(19) United States
(12) Patent Application Publication
(10) Pub. No.: US 2006/0160055 A1
(43) Pub. Date: Jul. 20, 2006

(54) Learning program, method and apparatus therefor

(75) Inventor: Takahiro Osoegawa, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/132,200

(22) Filed: May 19, 2005

(30) Foreign Application Priority Data
Jan. 17, 2005 (JP) 2005-009222
Apr. 15, 2005 (JP) 2005-118142

(51) Int. Cl. G09B 3/00

(52) U.S. Cl. 434/350; 434/362

(57) ABSTRACT

The learning server requests an answer by presenting a question to a pupil terminal device, analyzes the answer received from the pupil terminal device to determine the answer to be correct or incorrect, and displays the result of determination on the pupil terminal device. The status of progress of other pupils is displayed on the pupil terminal device as registered together with the status of progress of the pupil in question, and furthermore, answers of the other pupils are displayed on the pupil terminal device. The status of progress of the other pupil showing similar time lapses from the start of learning is displayed together with the status of progress of the pupil in question on the pupil terminal device.

This application is a priority based on prior application No. JP 2005-9222, filed Jan. 17, 2005, and No. 2005-118142, filed Apr. 15, 2005 in Japan.

### BACKGROUND OF THE INVENTION

1. Field of the Invention

The present invention relates to a learning program, a method and an apparatus for making pupils learn remotely by the use of a network environment, particularly a learning program, a method and an apparatus for such purposes having a mechanism for giving pupils an incentive to study.

2. Description of the Related Art

In a self-learning system using a network environment, it is the conventional practice to provide from a server a terminal device serving as a client with teaching materials and tasks so that pupils (participants) individually study the teaching materials, and upon the completion of learning, answer the tasks.

The self-learning system has many favorable merits in that it does not require costs caused by arrangement and troubles for lecturers and class rooms as in the conventional collective teaching, and pupils can learn at any time by the use of spare time and their own terminal devices, and is therefore popularly utilized in schools education, qualification class and corporate education and training.

In conventional self-learning systems, various mechanisms other than supply of teaching materials are proposed for the purpose of improving the learning effect of pupils who are studying teaching materials and tasks provided from a server.

These conventional learning systems include, for example, a system which causes growth of characters in response to the status of progress of the result of learning for a plurality of users and displays characters of the other participants (Japanese Patent Re-Publication No. WO02/019295), a system which outputs a hint in correspondence to the number of incorrect answers to a question (Japanese Unexamined Patent Application Publication No. 2002-040923), a system which outputs a hint in the case of a blank answer in correspondence to the number of blank answers (Japanese Unexamined Patent Application Publication No. 2001-350399), and a system which alleviates the burden of entering an answer by accumulating auxiliary reference materials to be used upon answering a question, and retrieving auxiliary reference materials in response to the question upon answering (Japanese Unexamined Patent Application Publication No. 2000-259072).

### SUMMARY OF THE INVENTION

However, in such a conventional self-learning system using a network, pupils perform learning and answering individually upon receipt of teaching materials and tasks provided one-sidedly. Individual pupils cannot know conditions of the other pupils. They sometimes feel solitude upon learning, and when they cannot maintain their learning will, a sufficient learning result cannot be expected.

It is an object of the present invention to provide a learning program, a method and an apparatus which improve the learning will and learning effect by creating an atmosphere which makes a pupil feel as if he/she were participating in a class together with other pupils while taking the form of self-learning.

For achieving this object, the present invention has the following configuration.

The present invention provides a learning program executed by a computer of a learning apparatus connected to pupils' terminals via a network. The learning program of the present invention causes the computer of the learning apparatus to execute:

a question processing step which presents a question to a pupil's terminal device and requests an answer;

an answer processing step which analyzes the answer received from pupil's terminal device to determine whether the answer is correct or not, and causes display of the result of determination on pupil's terminal device; and

a progress display processing step which causes pupil's terminal device to display the progress status of other pupils together with said pupil's own progress status.

The present invention has further a step of managing a received answer and the time lapse from the start of learning correlated to each other for each pupil, and the progress display processing step causes the terminal device of the pupil in question to display the status of progress of pupils having a similar time lapse from the start of learning required until the answer together with his/her own status of progress.

The answer processing step is to display answers from the other pupils on pupils' terminal devices. For example, the answer processing step displays answers of the other pupils on the terminal device of the above-mentioned pupil when another pupil is determined to make incorrect answers more frequently than a predetermined number of times for the same question. When there is no answer within a prescribed time lapse, the answer processing step may display the answers of other pupils as a hint on the pupil's terminal device. When an answer is determined to be correct for a question having a plurality of correct answers, the answer processing step displays the answer of such other pupil on the above-mentioned pupil's terminal device.

The answer processing step groups pupils showing time lapses of similar lengths from the start of learning, and displays answers of other pupils' answers within a group upon displaying answers of the other pupils on the pupil's terminal device.

The answer processing sep groups pupils showing similar score levels, and displays answers of other pupils' answers within a group upon displaying answers of the other pupils on the pupil's terminal device.

The present invention provides a learning method in which the learning apparatus is connected to pupils' terminal devices via a network. The learning method of the present invention comprises:

a question processing step which presents a question to a pupil's terminal device and requests an answer;

an answer processing step which analyzes the answer received from pupil's terminal device to determine whether the answer is correct or not, and causes display of the result of determination on pupil's terminal device; and

a progress display processing step which causes pupil's terminal device to display the progress status of other pupils together with the pupil's own progress status.

The present invention provides a learning apparatus to which pupils' terminal devices are connected via a network. The learning apparatus of the present invention comprises a question processing unit which presents a question to pupil's terminal device and requests an answer thereto;.an answer processing unit which analyzes the answer received from the terminal device of the pupil to determine whether the answer is correct or not, and displays the result of determination on the above-mentioned terminal device of the pupil; and a progress display processing unit which displays Pupil's own status of progress as well as the status of progress of the other pupils on the terminal device of the pupil.

Details of the learning method and the apparatus thereof according to the present invention are basically the same as in the learning program of the present invention.

According to the present invention, it is possible to create an atmosphere in which, upon starting learning, the status of progress of a pupil is displayed together with the status of progress of other pupils, and although he/she is individually participating in the learning class, he/she feels as if he/she is studying together with a plurality of friends.

The pupil will know his/her own status of progress by comparing it to progress of other pupil. If it is higher, he/she will make further efforts to maintain the current level, and if in delay, still further efforts to improve the progress, thus raising the learning will. Continued maintenance of these efforts will permit expectation of a sufficient learning effect.

By displaying the progress of other pupils when they had similar lengths of time lapse from the start of learning, for example, from the start of questions, to the time lapse of the pupil in question, even pupils who started learning at various points in time can know the progress of other pupils at times when they had similar lapses of time as his/her own learning time lapse, and in spite of separate and individual learning, an atmosphere as if he/she learns together with the other pupils.

In the present invention, when incorrect answers occur more than a predetermined number of times for the same question, a sense of unity with the other pupils as in an actual class is obtained by displaying answers of the other pupils as a hint. As the same time, since the final answer should be made at pupil's discretion, presentation of the correct answer is never pushing, thus providing a learning effect without causing interruption of pupil's reasoning or judgment.

In the present invention, even when one of the correct answers is entered from among the plurality of correct answers, the pupil can understand that there are another correct answers from display of other pupils' answers, thus making it possible to train thinking faculty, logical thinking ability and writing capabilities to understand various facets of things.

The above and other objects, features, and advantages of the present invention will become more apparent from the following detailed description with reference to the drawings.

### BRIEF DESCRIPTION OF THE DRAWINGS

FIG. 1 is a block diagram illustrating a functional configuration of the learning apparatus according to the present invention;

FIG. 2 is a descriptive view of the computer hardware environment used for the server and the client shown in FIG. 1;

FIG. 3 is a descriptive view of the correct answer file shown in FIG. 1;

FIG. 4 is a descriptive view of the synonym dictionary file shown in FIG. 1;

FIG. 5 is a descriptive view of the answer history file shown in FIG. 1;

FIGS. 6A and 6B are descriptive views of the question display screen according to the embodiment shown in FIG. 5;

FIGS. 7A and 7B are descriptive views of the model answer screen and an erroneous answer screen for the question shown in FIGS. 6A and 6B;,

FIG. 8 is a descriptive view of a screen displaying the status of progress and answers of the other pupils for an incorrect answer;

FIGS. 9A and 9B are flowcharts of an embodiment of learning processing by the learning server shown in FIG. 1; and

FIGS. 10A and 10B are flowcharts of another embodiment of learning processing by the learning server shown in FIG. 1.

### DETAILED DESCRIPTION OF THE PREFERRED EMBODIMENTS

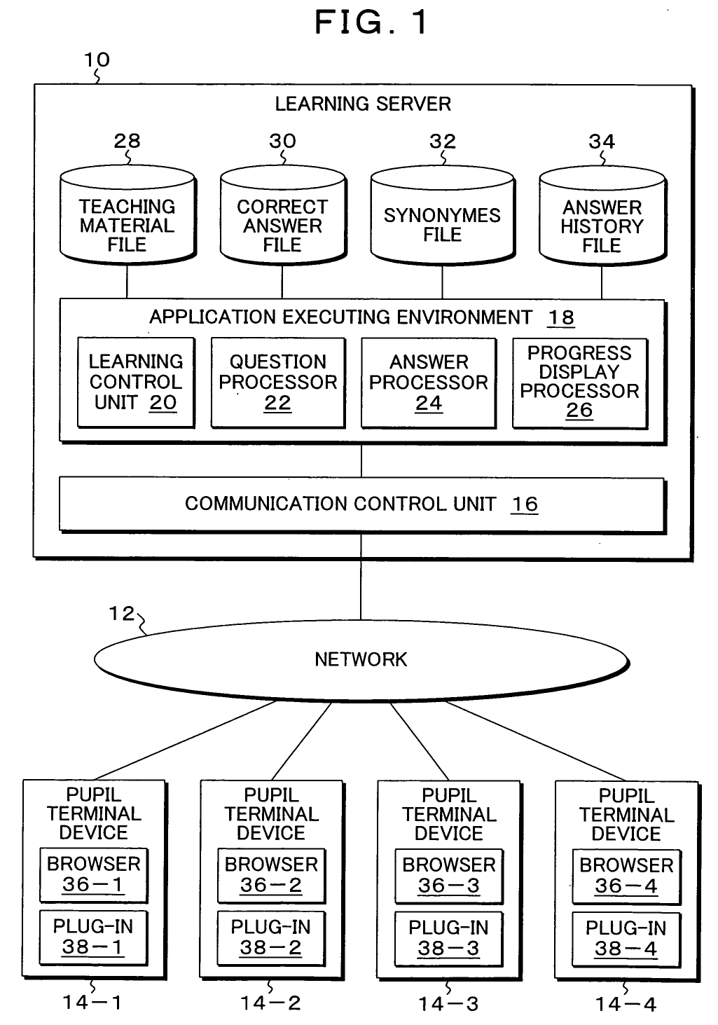

FIG. 1 is a block diagram illustrating the functional configuration of the learning apparatus of the present invention. In FIG. 1, a learning server 10 serves as the learning apparatus of the present invention. Pupils' terminal devices 14-1 to 14-4 using personal computers are connected to the learning server 10 via a network 12 such as the internet. The pupil's terminal device 14-1 may well be a portable terminal PDA or the like apart from a personal computer. A communication control unit 16 and an application executing environment 18 are provided in the learning server 10. To execution of the learning processing of the present invention, functions such as a learning control unit 20, a question processing unit 22, an answer processing unit 224, and a progress display processing unit 26 are provided in the application executing environment 18. These functions are executed through implementation of the program. A teaching material file 28, a correct answer file 30, synonym dictionary file 32 and an answer history file 34 are provided in the application executing environment 18 as files (tables) used in the learning server of the present invention. Browsers 36-1 to 36-4 and plug-ins 38-1 to 38-4 are provided in the pupils' terminal devices 114-1 to 114-4 connected to the learning server 10 via the network 12. The browsers 36-1 to 36-4 perform perusal of the web page and receipt and display of data such as HTML necessary for learning, including supply of teaching materials and response to the presentation of questions by accessing the web page of the learning server 10. Plug-ins 38-1- to 38-4 provide appropriate methods necessary for text processing, image processing and the like required for learning processing of the present invention. Therefore, 14-1 will hereafter be described as representing the pupil terminal device.

The learning control unit 20 provided in the application executing environment 18 of the learning server 10 supplies teaching material information read out from the teaching material file 28 in accordance with a predetermined learning schedule to accesses of the pupil's terminal devices 14-1 to 14-4 to make the pupils (participants) conduct self-learning. The learning control unit 20 causes processing of question and answer through control on the question processing unit 22 and the answer processing unit 24 for every run of advance of the contents of the teaching materials in a prescribed sequence by supplying the teaching materials to the pupils. The question processing unit 22 presents questions to the pupil's terminal devices 14-1 to 14-4 side, requesting an answer. Supply of questions in this case is performed by means of images and texts. In response to the presentation of questions by the question processing unit 22, the pupil's terminal devices 14-1 to 14-4 display the contents of questions by means of the browser 36-1 in the form of a still image, an animation or a text, and request an answer by the free answering method of filling an answer column. Therefore, the pupil selects an answer while watching the question screen, and upon the completion of this selection, fills the answer column of the question screen with the selected answer for response by the free answering method in accordance with the text document. Of course, depending upon the question, the selective answering method may be combined with the free answering method. The answer processing unit 24 analyzes an answer received from the pupil's terminal device 14-1 side, determines whether the answer is correct or not by using the correct answer file 30 and the synonym dictionary file 32, and displays the result of determination on the pupil's terminal device 14-1 side.

When analyzing the answer by the answer processing unit 24, the partial agreement method based on a keyboard may be applied to the answer of the pupil. When the answer is correct, a branching destination is set, and the process advances to the next learning screen. When an answer from the pupil's terminal device is determined to be incorrect, presentation of the question is repeated up to a predetermined number of times, and if the answer is still incorrect, the status of progress is displayed by the progress display processing unit 26 as described above, or a display is made to present answers of the other pupils as a hint. When an answer received from the pupil's terminal device is correct, the answer processing unit 24 furthermore accumulates the answer in the answer history file. The answer history file 34 manages the time lapse and the contents of the answer regarding a question for each pupil as will be described later. The progress display processing unit 26 causes the pupil's terminal devices 14-1 to 14-4 to display the status of progress of each pupil as required upon presentation of a question, and simultaneously, the progress status of the other pupils. The display of the status of progress of the pupil in question and the other pupils by the progress display processing unit 26 includes display of the lapse of time from the start of learning, or more specifically, the total time lapse from the start for each of a plurality of questions presented sequentially, together with the status of progress of the other pupils when they show similar time lapses. As a result, although the pupil's terminal devices 14-1 to 14-4 are used independently for learning of the pupil under the effect of the learning server 10, a sense of unity as if the pupil in question participates in the same class as the other pupils as in an actual class is created and can actively study without feeling solitude by displaying pupil's own status of progress together with the status of progress of the other pupils upon showing similar time lapses as that of the pupil in question as required during the answering operation on the question presenting screen. Display of the status of progress by the progress display processing unit 26 is performed for example at the following timings:
(1) When incorrect answers occur for a question more than a predetermined number of times;
(2) When no answer is received for a question within a predetermined assumed lapse of time; or
(3) Always displayed on the question presenting screen.

On the other hand, when an answer is received from the pupil terminal device and it is determined to be correct or incorrect, the answer processing unit 24 displays as required answers of the other pupils. The answers of the other pupils are displayed as a rule for the purpose of providing a hint regarding incorrect answers. More specifically, when the answer for a question is determined to be incorrect more than a predetermined number of time, correct answers of the other pupils are read out from the answer history file and displayed on the pupil terminal device. This enables the pupil whose answer is determined to be incorrect to obtain a hint about the question by seeing the answers of the other pupils and read the correct answer.

Correctness of the answer of the other pupil displayed relative to the incorrect answer is not shown. Only the answer itself of the other pupil is indicated as it is. The answer of the other pupil displayed is not therefore a model answer, and the pupil in question would consider by himself/herself what is the correct answer with reference to the answer of the other pupil. On the other hand, a question may have a plurality of correct answers. For such a question having a plurality of correct answers, the answer processing unit 24, if determining that an answer received from the pupil terminal device is correct after analysis, causes the pupil terminal device to display a correct answer of the other pupil. The pupil in question who watches the display of the another correct answer of the other pupil understands that his/her answer is correct, and at the same time, that there is another correct answer among answers of the other pupils, thus obtaining capabilities to grasp things from various aspects regarding the correct answer. For the display of answers of other pupils, the answer processing unit 24 may:

(1) group pupils of similar time lapses from the start of learning, for example, from the start of questions, and display answers of other pupils within the group in a prescribed number; or

(2) group pupils of similar score levels, and display answers of other pupils within a group.

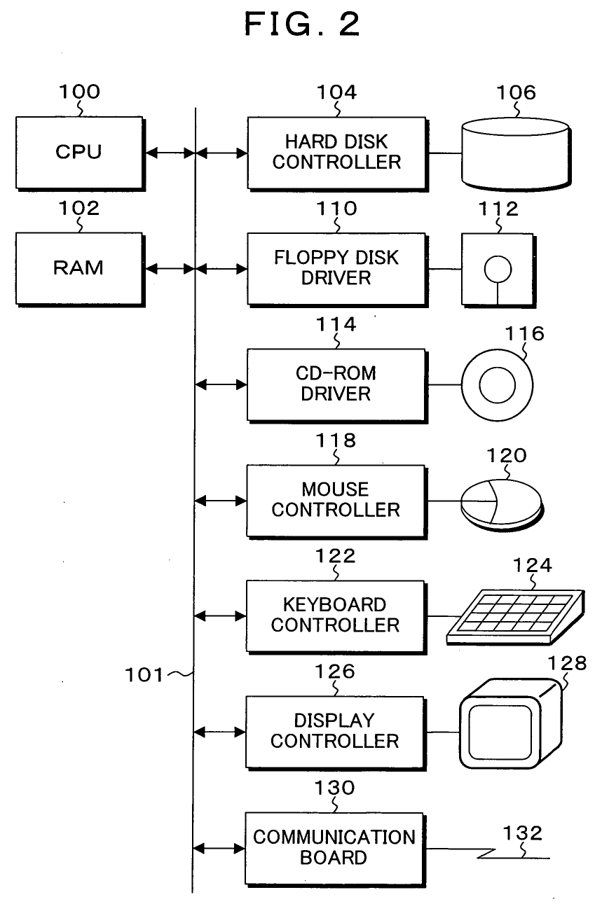

The learning server 10 shown in FIG. 1 is achievable by computer hardware resources as shown in FIG. 2. In the computer illustrated in FIG. 2, a RAM 102, a hard disk controller (software) 104, a floppy disk driver (software) 110, a CD-ROM driver (software) 114, a mouse controller 118, a keyboard controller 122, a display controller 126, and a communication board 130 are connected to a bus 101 of a CPU 100. The hard disk controller 104 connects a hard disk drive 106, loads a program for executing the learning processing of the present invention, and upon starting up the computer, calls a necessary program from the hard disk drive 106, deploys it on the RAM 102, and implements the same by means of the CPU 100. The floppy disk driver 110, connected to a floppy disk drive (hardware) 112, can read and write from and into the floppy disk R. A CD drive (hardware) 116 is connected to the CD-ROM driver 114 which can read data and programs stored in a CD.

The mouse controller 118 transmits an input operation of the mouse 120 to the CPU 100. The keyboard controller 122 transmits an input operation of the keyboard 124 to the CPU 100. The display controller 126 performs a display on the display unit 128. The communication board 130 conducts communication with the pupil terminal devices via a communication line 132. The computers serving as pupil terminal devices 14-1 to 14-4 shown in FIG. 1 form the same hardware environment as that shown in FIG. 2.

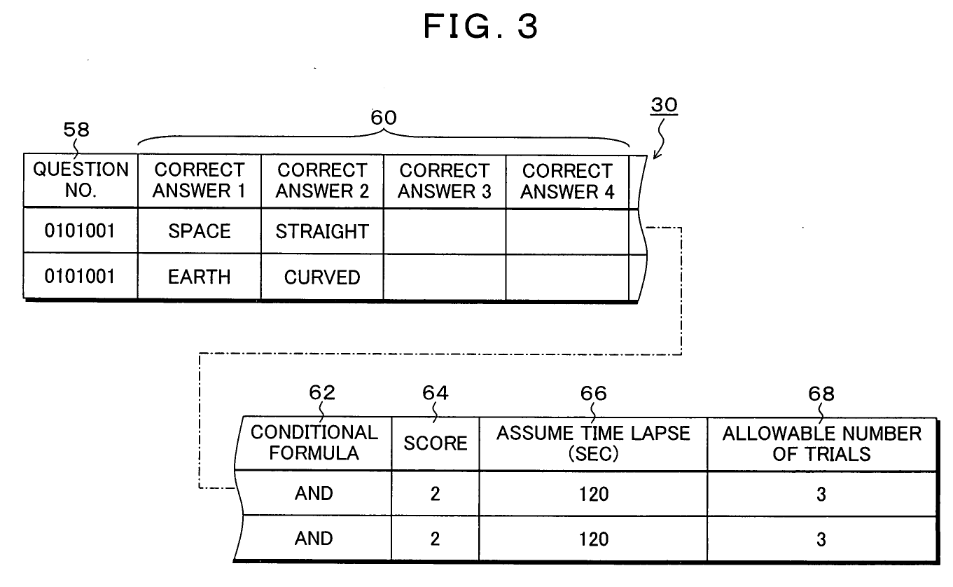

FIG. 3 is a descriptive view of a correct answer file 30 provided in the learning server 10. In FIG. 3, the correct answer file 30 is composed of a question number 58, a correct answer keyword 60, conditional formulae 62, scores 64, assumed time lapses 66, and allowable number of trials 68. A question number is set for each question. A plurality of correct answer keywords 60 can be registered as in the correct answers 1 to 4, and store keywords necessary for a correct answer. The conditional formulae 62 set conditional formulae for determining a plurality of keywords of the correct answer keyword 60 to be correct answers. For example, for the question No. “01010001”, correct number 1 represents “space”, and correct answer 2, “straight”. Since the conditional formula 62 in this case is “AND”, an answer is determined to be correct when logical products, ANDs, of correct answers 1 and 2 are obtained. Scores 64 are set for the individual question numbers. In this case, when a question number has a plurality of correct answers, the score is added under an OR condition (addition). In the example shown in FIG. 3, there are two question numbers “01010001” as the question number 58, and the score 64 of 2 points is obtained. In the case of a correct answer, therefore, 4 points would be added under OR condition. The assumed time lapse 66 sets a time lapse, as seen from the system side, necessary during the period from presentation of a question to achievement of a model answer. The allowable number of trials 68 sets an allowable number of trials, i.e., a a number of incorrect answers, which is set forth as 3 in this example. The time lapse from the start of a question exceeds an assumed time lapse or the number of incorrect answers exceeds an allowable number of trials in accordance with the assumed time lapse 66 or the allowable number of trials 68 in the correct answer file 30, a hint is provided through display of the answer of the other pupil as shown in the answer processing unit 24 of FIG. 1.

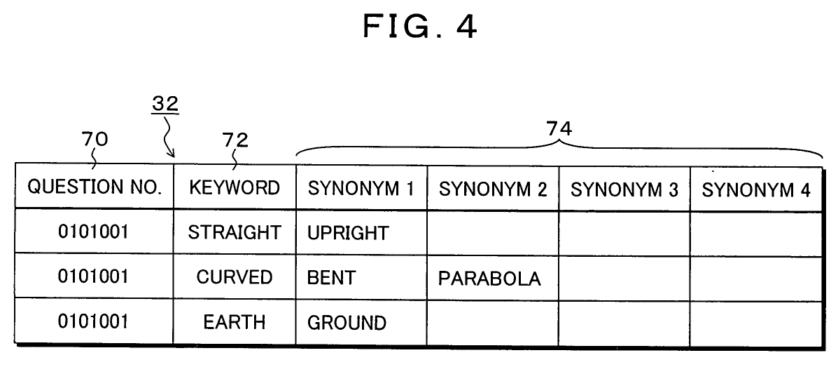

FIG. 4 is a descriptive view of the synonym dictionary file 32 provided in the learning server 10 shown in FIG. 1. The synonym dictionary file 32 is composed of a question number 70, a keyword 72, and a synonym 74 which may be registered in a plural number. The question number 70 corresponds to the question number 58 of the correct answer file 30 shown in FIG. 3. The keyword 72 sets anticipated keywords of synonyms of the correct answer keyword 60 of the correct answer file 30 shown in FIG. 3 such as “straight”, “curved”, and “earth”. Synonyms for the words registered in the keywords 72 are registered as synonyms 74. For example, as a synonym 1 for “straight” of the keyword 72, the word “linear” is registered. As a synonym 1 for the keyword “curved”, the word “bent” is registered, and as a synonym 2, the word “parabola” is registered. As a synonym 1 for the keyword “earth”, the word “ground” is registered. Use of the correct answer file 30 shown in FIG. 3 and the synonym dictionary 32 shown in FIG. 4 as described above provides the following advantages. In a text answer document carried out as a free input type answer for a question presented by the pupil terminal device, the text answer document is word-analyzed and comparison and collation are performed by the partial agreement method. If a partial agreement set in the correct answer keyword 60 of the correct answer file 30 is obtained, the answer is determined to be correct. Even when it does not agree with the keyword of the correct answer file 30, the answer is deemed to be correct if a partial agreement of synonyms is obtained in the reference to the synonym dictionary file 32. In this case, a correct answer obtained with a partial agreement with the correct answer keyword of the correct answer file 30, this correct answer is adopted as the model answer, and the correct answer including only a partial agreement of synonyms of the synonym dictionary file may be determined to be simply a correct answer.

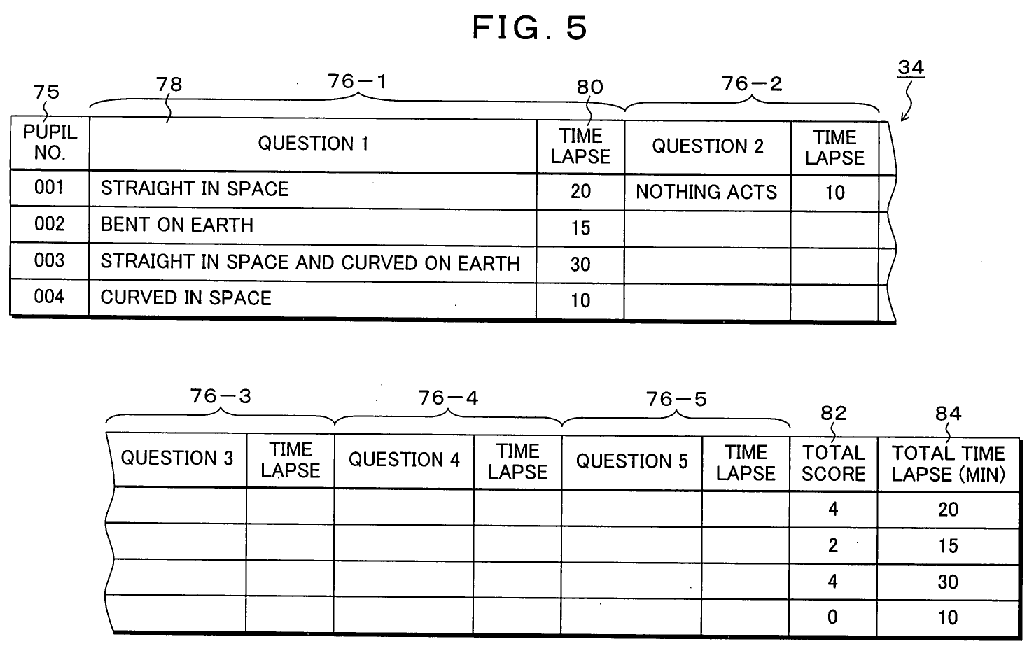

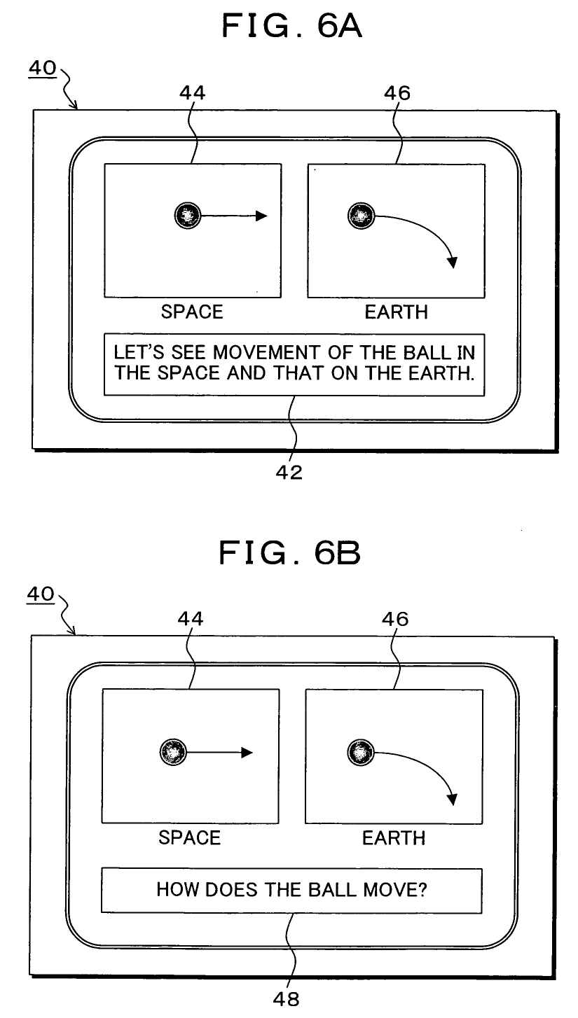

FIG. 5 is a descriptive view of the answer history file 34 provided in the learning server 10 shown in FIG. 1. In FIG. 5, the answer history file 34 is composed of a pupil number 75, answer information 76-1 to 76-5, a total score 82, and a total time lapse 84. The answer information 76-1 to 76-5 store pupil's answers 78 and the time lapses 80 up to the answer so as to show information about the answers. The total score 82 stores a total score of the pupil up to that point in time. Time lapses from the start of questions are included in the time lapse 80 in the answer information 76-1 to 76-5. The total time lapse is the total of time lapses for the individual questions. The answer history file 34 described above is utilized in the display of answers of the other pupils provided in the answer processing unit 24 provided in the learning server 10 shown in FIG. 1, and a progress display is performed together with answers of the other pupils in the progress display processing unit 26. For example, since there is a period of time of 30 minutes before input of answers, the progress display conducted by the progress display processing unit 26 covers a display of the other pupils' status of progress upon the lapse of 30 minutes from the start of questions. In the example shown in FIG. 5, information is displayed to the effect that pupil No. 001 has already made answers to questions 1 and 2; pupil No. 002 has made an answer to question 1; and pupil No. 4 is still entering an answer only to question 1. More specifically, when a pupil having started learning of teaching materials provided by the learning server participates in the learning once and then later participates in the class again, the total time lapse of this pupil is acquired with reference to the answer history file 34. Then, other pupils having similar total time lapses are grouped. When, for the presented question, the number of incorrect answers exceeds an allowable number of trials set in the correct answer file 30, the answers of the other pupils thus grouped are read out from the answer history file 34 and displayed as a hint. It is also possible to group pupils showing scores on similar level from the total scores up to the same already answered question with reference to the answer history file 34, and to read out examples of answer of the other pupils grouped in terms of the score level when the number of incorrect answers exceeds the allowable number of trials from the answer history file 34 to display the same as a hint. FIG. 6 is a descriptive view of a question display screen in the embodiment shown in FIG. 1, covering an example in which pupils learn a learning material of Newton's first law. FIG. 6(A) illustrates a question screen 40 presented to the pupil terminal device from the learning server 10 on the pupil terminal device 14-1. A message “Let us see the move of a ball in the space and the move of a ball on the earth” is set on the question display column 42 on the screen. In correspondence to this, an image 44 such as an animation or an animated cartoon showing the move of a ball in the space and an image 46 such as an animation or an animated cartoon showing the move of a ball on the earth is displayed on the screen. The display of a text document in the question display column 42 may be accompanied simultaneously with a voice output.

Upon the completion of the display of the question screen 40 shown in FIG. 6(A), the screen is switched over into a question screen 40 of FIG. 6(B), and a question “How does a ball move?” is displayed in the question display column 48.

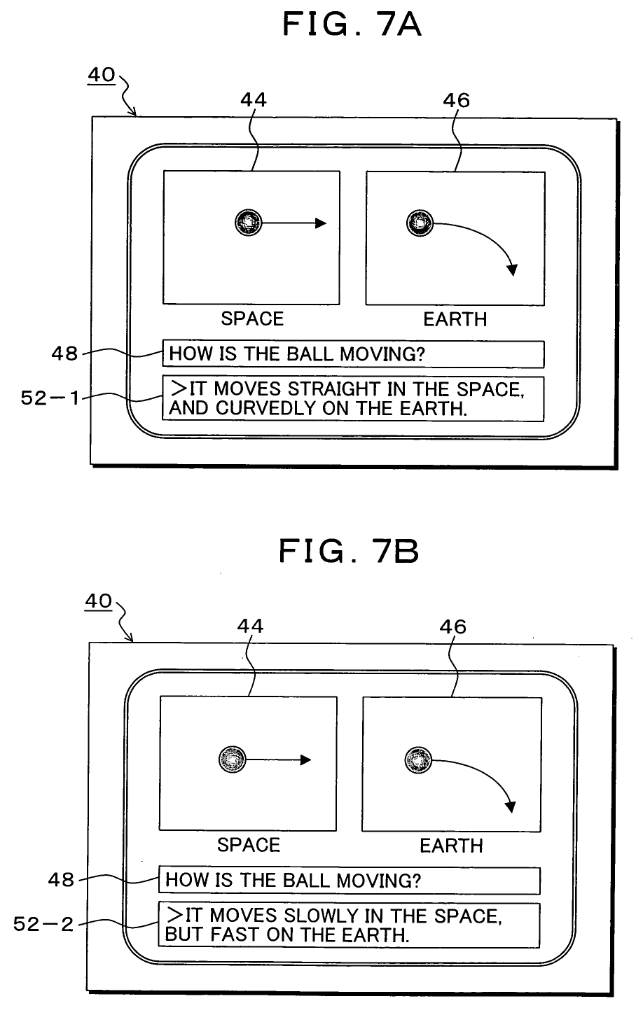

FIG. 7 is a descriptive view of the model answer screen and the answer screen to the question shown in FIG. 6. FIG. 7(A) is a model answer screen. An answer column 52-1 is displayed under the question display column 48 in the question screen 40. The pupil fills the answer column 52-1 with an answer “The ball goes straight in the space and draws a curved trajectory on the earth.” to respond to the learning screen. The learning server receives the answer of this pupil and analyzes it in the answer processing unit 24. Analysis of the answer is determined with reference to the correct answer file 30 shown in FIG. 3 and the synonym dictionary file 32 shown in FIG. 4. Since the answer shown in FIG. 7(A) contains all the keywords “space”, “straight”, “earth”, and “curved” in the correct answer keywords 60 in the question number 58 “01010001” of the correct answer file 30, it is determined to be a correct answer under logical product condition in accordance with the conditional formula 62. Furthermore, as all the correct answer keywords are contained, it is determined to be a model answer, obtaining a score of 64 and 2 points. If the pupil number is “003” in this case in the answer history file 34 shown in FIG. 5, the answer “straight in the space and curved on the earth” is registered in the answer column 78 of the answer information 76-1, and for example, a time “30 minutes” is registered as the time lapse 80. A total score 82 of 4 points is recorded since this is a case having two correct answers each having 2 points. The total time lapse 84 is “30 minutes” as for the time lapse 80, because of the single question. FIG. 7(B) represents a question screen 40 in the case of an erroneous answer. An answer “slower in the space and faster on the earth” is written by the pupil in the answer column 52-2. The learning screen 10 receiving this answer determines that the answer is incorrect, since although a partial agreement is obtained for the keywords “space” and “earth” with reference to the correct answer file 30 of FIG. 3 and the synonym dictionary file 32 of FIG. 4, no partial agreement is available for “straight” and “curved”, and an output cannot be obtained from the conditional formula. For an incorrect answer, no registration is conducted in the answer history file 34 of FIG. 5.

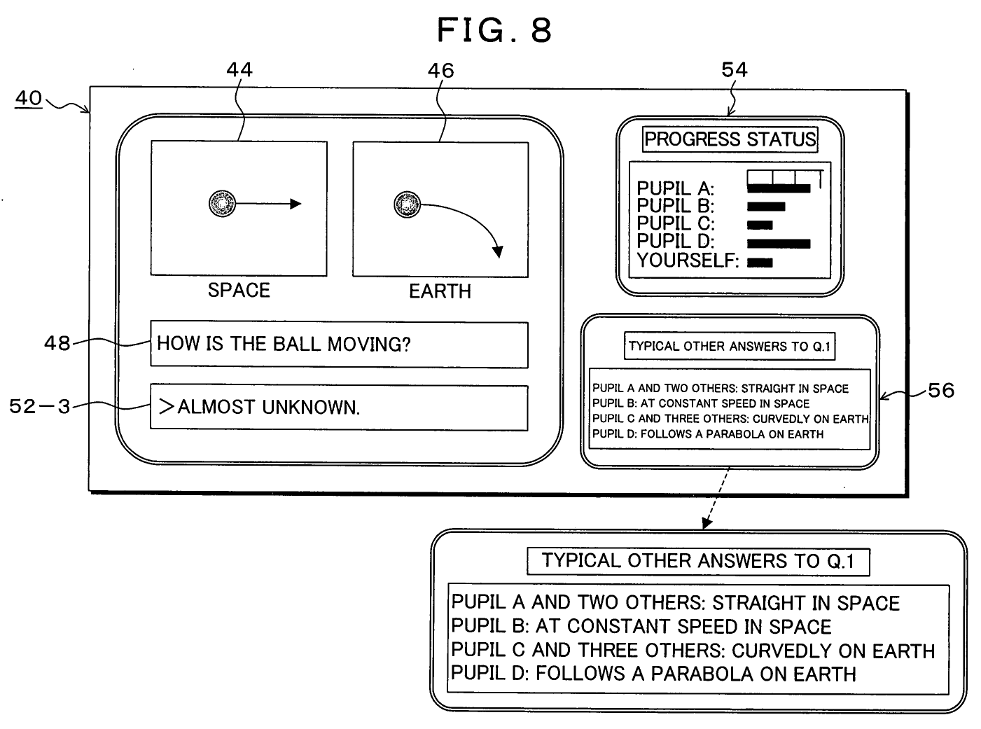

FIG. 8 is a descriptive view of the question screen displaying the status of progress and answers of the other pupils for an incorrect answer. In FIG. 8, upon the completion of the third answering by the pupil in the answer column 52-3, all the answers are determined to be incorrect and a message “I don't understand the questions almost at all” is added. When the number of incorrect answers exceeds a predetermined number of times, a progress display 54 and an answer history display 56 are made to the right of the question screen 44. In the progress display 54, the status of progress for other pupils A, B, C and D falling under the same group having similar time lapses at the same point in time upon the same time lapse as the pupil in question is displayed on the basis of the total time lapse in the answer history file 34 shown in FIG. 5, together with the progress of pupil in question. By watching the progress display, the pupil in question understands that, upon the same time lapse, D has made a considerable progress in learning as compared with himself/herself, that C is on almost the same level, and that he/she is on a lower level among the five pupils. Because he/she would get behind the others without learning more actively, it is possible to improve his/her learning will in an atmosphere similar to that in a usual collective learning, and thus to urge him/her to continue efforts. As a hint for solving the current number of incorrect answers exceeding the predetermined number, the answers of pupils A, B, C and D are displayed as the progress display in the answer history display 56. By watching the answers of the other pupils in the answer history display 56, he/she can consider what Newton's first law is to express as to the move of the ball in the space and the move of the ball on the earth in the question in the question display column 48 and thus achieve the correct answer. This display of the other pupils in the answer history display 56 may be accompanied by a voice output together with the text display. By doing so, he (she) will be able to know how the other pupils answer the question as in the same atmosphere as in an actual class, and make his (her) own answer with this as a hint.

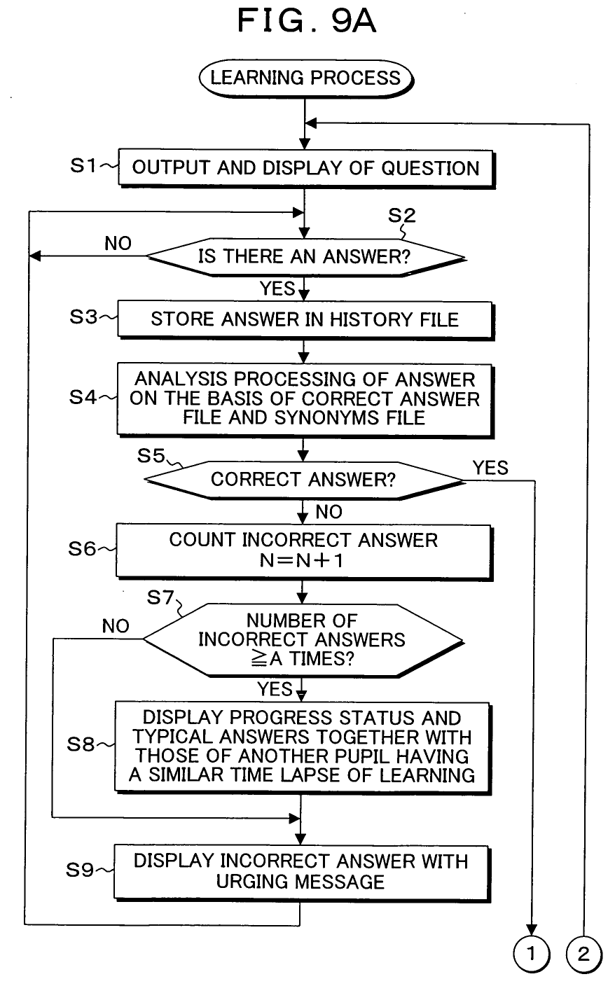

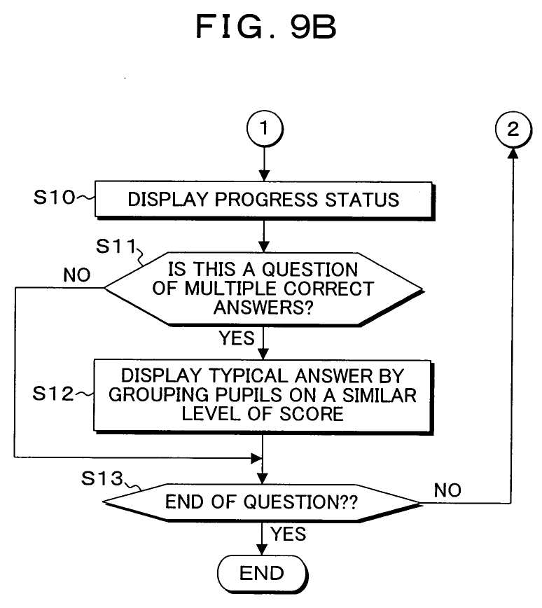

FIGS. 9A and 9B are flowcharts illustrating an embodiment of learning processing of the present invention in the learning server 10 shown in FIG. 1. In FIGS. 9A and 9B, the question processing unit 22 of the learning server 10 conducts an output display of a question to the pupil terminal device 14-1 in step S1. In step S2, when an answer from the pupil terminal device 14-1 is determined to have been received, the process advances to step S3 for the answer processing unit 24 to store the answers in the answer history file. Then in step S4, analysis processing of the answers is carried out by the partial agreement retrieval or the like on the basis of the correct answer file 30 and the synonym dictionary file 32, and in step S5, the answers are determined to be correct or incorrect. If the answer is incorrect, the process goes to step S6. After counting up incorrect answer count N by one in step S6, in step S7, it is checked whether or not the number of incorrect answers exceeds the set number of times A of the allowable number of trials 68 in the correct answer file 30 shown in FIG. 3. If the number is under A times, the incorrect answer is displayed in step S9. The question is displayed again to display an urging message, thereby returning to step S2. If the number of incorrect answers exceeds A times in step S7, as a result of repetition of steps S2 to S6, the process advances to step S8, and the progress display processing unit 26 causes display of the status of progress at answer of the pupil using the pupil terminal device 14-1 together with the progress of the other pupils upon the lapse of similar periods of learning on the pupil terminal device 14-1. Then returning to step S9, an urging message for presenting the question over again is displayed by displaying the incorrect answer. When a correct answer is determined in step S5, the process advances to step S10. The progress display processing unit 22 displays the status of progress of the pupil in question on the pupil terminal device with the progress of the other pupils upon the lapse of similar periods of time lapses of learning, for example. Then in step S11, it is checked whether or not the question has a plurality of correct answers. If it is a question having a plurality of correct answers, the process goes to step S12, in which pupils showing similar levels are grouped, and their answers (correct answers) are displayed. This enables the pupil in question to recognize that there are correct answers other than his/her own correct answer for a question having a plurality of correct answers, and thus to made learning to understand things in various facets. Then in step S13, it is checked whether or not the question comes to an end. If it does, the process returns to step S1 to carry out display of the next question, and a similar processing is repeated. When all questions are determined to have been completed in step S13, the processing is completed. Storage of answers in the answer history file 34 in step S3 is temporary until determination of a correct or an incorrect answer. When a correct answer is determined in step S5, storage in the answer history file becomes final together with the time required until achievement of a correct answer. Not only correct answers but also incorrect answers may be stored in the answer history file 34 and a mixture of correct and incorrect answers may be displayed on the pupil terminal device 14-1 so that the pupil can find a hint from among the mixture of correct and incorrect answers.

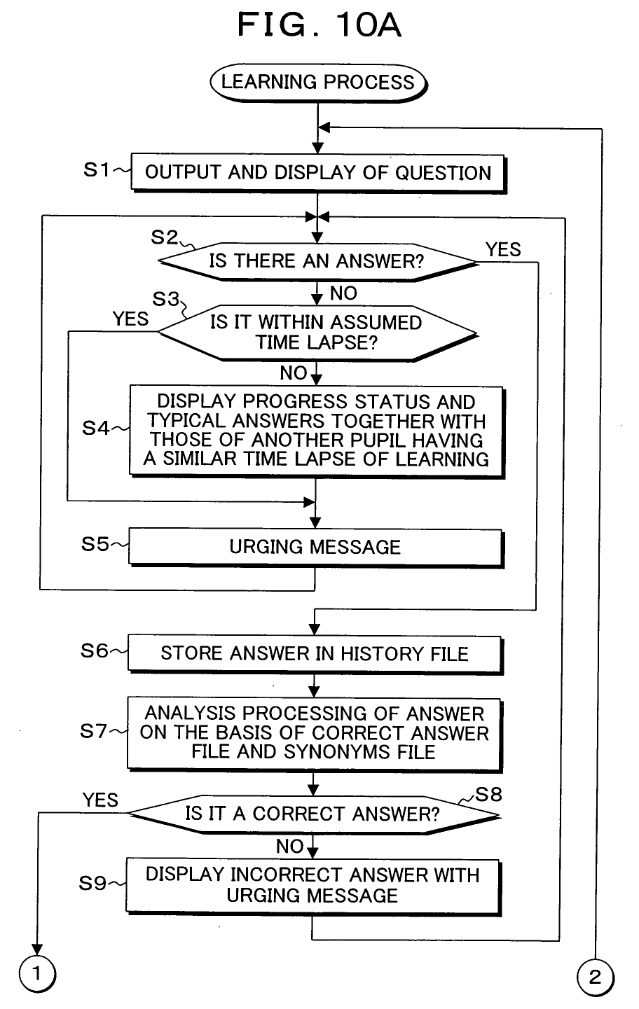

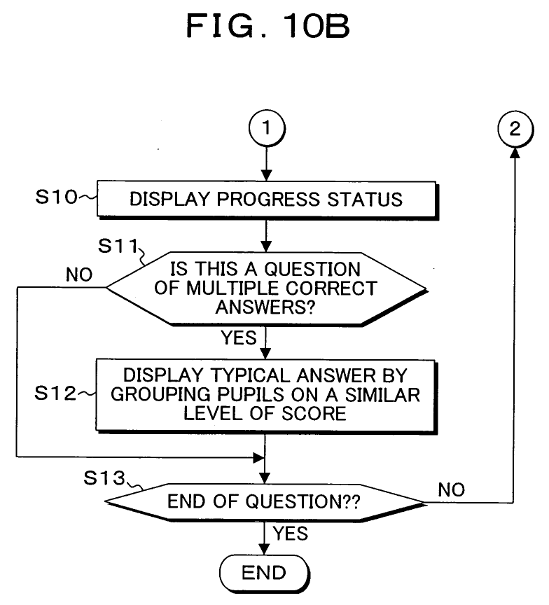

FIGS. 10A and 10B are flowcharts of another embodiment of the learning processing based on the learning server 10 shown in FIG. 1. In this embodiment, when no answer is received within an assumed period of time set for a question, the status of progress and answers of other pupils are displayed. In FIG. 10, the question processing unit 22 of the learning server 10 output-displays a question to the pupil terminal device 14-1 in step S1, and the answer processing unit 24 checks the presence of an answer in step S2. If no answer is received, it is checked whether or not it is within an assumed time lapse set for a question shown in the correct answer file 30 of FIG. 3 in step S3, and if within the assumed time lapse, an urging message for urging the pupil to enter an answer is displayed in step S5. After the lapse of the assumed period of time in step S3, the process advances to step S4. The progress display processing unit 26 displays the status of progress of the pupil using the pupil terminal device 14-1 together with the status of progress of other pupils upon the lapse of similar periods of time of learning, and displays examples of answer at a hint. If the presence of an answer is determined in step S2 upon display of these examples of answer of the other pupils as a hint, the answer processing unit 24 stores the answer in the answer history file 34 in step S6, and then, a correct or incorrect answer is determined through an analyzing processing of the answer on the basis of the correct answer file 30 and the synonym dictionary file 32 in step S7. When the answer is determined to be incorrect in step S8, the fact is displayed in step S9 and an urging message is displayed. When the answer is determined to be correct in step S8, the status of progress is displayed in step S10 by the progress display processing unit 26. Then in step S11, for a question having a plurality of correct answers, pupils having similar score levels are grouped and their typical answers are displayed in step 12. Steps S1 to S12 are repeated until the end of question is determined in step S13.

The present invention provides a program for a learning processing executed in an application executing environment 18 of the learning server shown in FIG. 1, and this program has processing contents in accordance with the flowchart shown in FIG. 9 or 10.

For a correct answer of the pupil stored in the answer history file 34 provided in the learning server 10 of the present invention is read out from the answer history file 34 after the end of a series of learning processes through a word analysis or a synonym analysis, thus obtaining keywords of the correct answer. These keywords can be effectively utilized for dynamic update and question of the learning system by adding them to the correct answer keywords 60 of the correct answer file 30 shown in FIG. 3 or the synonyms of the synonym dictionary file 32 shown in FIG. 4.

For the question screens 40 shown in FIGS. 6 to 8, an assumed time lapse 66 is set for each question as shown in the correct answer file 30 shown in FIG. 3. The pupil may be urged to enter a correct answer within a prescribed period of time by displaying a remaining period of time based on the assumed time lapse from the start of display of a question.

The present invention includes appropriate variations without impairing the objects and advantages thereof, and is not limited by the numerical values shown in the above-mentioned embodiments.

What is claimed is:

1. A learning program for a learning apparatus connected to a pupil terminal device via a network to execute:
an answer processing step of presenting a question to said pupil terminal device and requesting an answer;
an answer processing step of determining an answer received to be correct or incorrect through analysis, and displaying the result of determination on said pupil terminal device; and
a progress display processing step of causing said pupil terminal device to display the status of progress of the pupil in question as the status of progress of other pupils.

2. The program according to claim 1, further comprising:
a step of managing said received answer and the time lapse from the start of learning correlated to each other for each pupil;
wherein said progress display processing step causes said pupil terminal device to display the status of progress of pupils having a similar time lapse from the start of learning required until input of said answer, together with his/her own status of progress.

3. The program according to claim 1, wherein:
said answer processing step causes said pupil terminal device to display answers of other pupils.

4. The program according to claim 3, wherein:
said answer processing step causes said pupil terminal device to display, when the answer to a question is determined to be incorrect more than a prescribed number of times, an answer of other pupil as a hint.

5. The program according to claim 3, wherein:
said answer processing step causes said pupil terminal device, when no answer is received within a prescribed time lapse, answers of the other pupils as a hint.

6. The program according to claim 3, wherein:
said answer processing step causes said pupil terminal device, when an answer to a question having a plurality of correct answers is determined to be a correct answer, to display answers of other pupils.

7. The program according to claim 3, wherein:
upon displaying the answers of the other pupils, said answer processing step groups pupils showing similar time lapses from the start of learning, and causes said pupil terminal device to display answers of the other pupils in said group.

8. The program according to claim 3, wherein:
said answer processing step causes, when displaying the answers of the other pupils, said pupil terminal device to group other pupils showing similar score levels, and display the answers of the other pupils within the group on said pupil terminal device.

9. A learning method in which a pupil terminal device is connected to a learning apparatus via a network comprising:
a question processing step of presenting a question to said pupil terminal device and requesting an answer;
an answer processing step of determining an answer received to be correct or incorrect through analysis, and displaying the result of determination on said pupil terminal device; and
a progress display processing step of causing said pupil terminal device to display the status of progress of the pupil in question and the status of progress of other pupils.

10. The learning method according to claim 8, further comprising:
a step of managing by correlating said received answer for each of said pupils with the time lapse from the start of learning;
wherein said progress display processing step causes said pupil terminal device to display the status of progress of pupils when they show similar time lapses from the start of learning required until input of said answers, together with the status of progress of the pupil in question.

11. A learning apparatus to which a pupil terminal device is connected via a network, comprising:
an answer processing unit which presents a question to said pupil terminal device and requests an answer;
an answer processing unit which determines an answer received to be correct or incorrect through analysis, and displays the result of determination on said pupil terminal device; and
a progress display processing unit which causes said pupil terminal device to display the status of progress of the pupil in question and the status of progress of other pupils.

12. A learning apparatus according to Note 11, further comprising:
means for managing by correlating said received answers for each of said pupils with the time lapse from the start of learning;
wherein said progress display processing unit causes said pupil terminal device to display the status of progress of pupils when they show similar time lapses from the start of learning required until input of said answers, together with the status of progress of the pupil in question.
